(19) United States
(12) Patent Application Publication
(10) Pub. No.: US 2003/0132952 A1
(43) Pub. Date: Jul. 17, 2003

(54) Jukebox user interface

(76) Inventors: Jeffrey S. Davis, Seattle, WA (US); Erik E. Chelstad, Seattle, WA (US); Scott K. James, Seattle, WA (US); Stephan L. Poole, Seattle, WA (US)

Correspondence Address: Michael S. Smith, BLACK LOWE & GRAHAM PLLC, 816 Second Avenue, Seattle, WA, 98104, US

(21) Appl. No.: 10/051,419

(22) Filed: Jan. 17, 2002

(51) Int. Cl. G09G 5/00

(52) U.S. Cl. 345/716

(57) ABSTRACT

The present invention provides a digital jukebox with a more user-friendly interface. The jukebox includes a display, memory, a processor, and control devices. The processor includes a graphical user interface component that generates an image for presentation on the display. The control devices when operated send signals to the processor for making selections presented on the display by the graphical user interface component.

### PRIORITY CLAIM

This application claims priority from Provisional Patent Application No. ______ filed pro se on Jan. 17, 2001, entitled “The Evolutionary Digital Jukebox” and bearing a serial number to be provided in a preliminary amendment as soon as the serial number can be retrieved.

### FIELD OF THE INVENTION

This invention relates generally to jukeboxes and, more specifically, to jukebox interfaces.

### BACKGROUND OF THE INVENTION

User interfaces for vinyl record jukeboxes have typically been just a single piece of paper that indicates a list of artists and songs next to selection numbers. Because the number of vinyl records stored in a vinyl record jukebox is a small number, this type of user interface works well. A compact disc (CD) jukebox has the ability of storing a large of number of CDs. Because of the volume of songs available on the CD jukebox, the user interface used for vinyl record jukeboxes does not work for the CD jukebox. CD jukeboxes typically use some form of page scrolling device, which flips hard copies of pictures or covers of CDs and allows a user to select songs by entering an associated identification number.

With the introduction of digital jukeboxes, the user interfaces described above are no longer applicable. This is because the number of digital music recordings that can be stored within a digital jukebox can far surpass the number of CD recorded songs that are stored in a CD jukebox.

Therefore, there exists a need for a customer friendly user interface for a digital jukebox that allows a user to easily progress through the large volume of songs stored in the digital jukebox. Otherwise, if the user interface for a digital jukebox does not provide the same ease of use as that in a vinyl disc jukebox or a CD jukebox, the customer will quickly lose interest and decide not to bother with the digital jukebox.

### SUMMARY OF THE INVENTION

The present invention provides a digital jukebox with a more user friendly interface. The jukebox includes a display, memory, a processor, and control devices. The memory stores graphic files and associated music files. The processor is coupled to the display and memory. The processor includes a graphical user interface component that generates an image for presentation on the display. The graphical user interface component includes an alphanumeric list component that generates selectable alphanumeric components, wherein the stored graphic and music files are associated with one or more alphanumeric components. The graphical user interface component also includes an album select component that generates images of albums for display based on a selection from the generated alphanumeric list and the associated graphic and music files, and a song selection component that generates a list of selectable songs based on the selection of an album image. The generated alphanumeric components, album images, and song list are displayed on the display. The control devices include a scrolling device, a switch device, and a song selection device. The scrolling device generates a scrolling signal when operated. The switch device generates a switching signal when operated. A song selection device generates a signal for selecting a song from the generated song list. The processor sends the generated scrolling signal to at least one of the alphanumeric list component, the album select component, or the song selection component based on the generated switching signal.

In accordance with further aspects of the invention, the scrolling device is a joystick.

In accordance with other aspects of the invention, the scrolling device is a dial.

In accordance with still further aspects of the invention, the switch scrolling device is a throw switch.

In accordance with yet other aspects of the invention, the switch scrolling device is a toggle switch.

In accordance with still another aspect of the invention, the album select component includes an album identification component for identifying an album from the generated album images. The graphical user interface further includes an album image component for generating an image associated with an identified album.

### BRIEF DESCRIPTION OF THE DRAWINGS

The preferred and alternative embodiments of the present invention are described in detail below with reference to the following drawings.

FIG. 1 is a block diagram illustrating a system used in conjunction with the present invention;

FIG. 2 is an example user interface formed in accordance with the present invention;

FIG. 3 is a perspective view of a jukebox embodying the user interface shown in FIG. 2;

FIG. 4 is a screen shot of an example user interface display formed in accordance with the present invention; and

FIG. 5 is a screen shot of a help screen for the user interface and user interface display shown in FIGS. 2 and 4.

### DETAILED DESCRIPTION OF THE PREFERRED EMBODIMENT

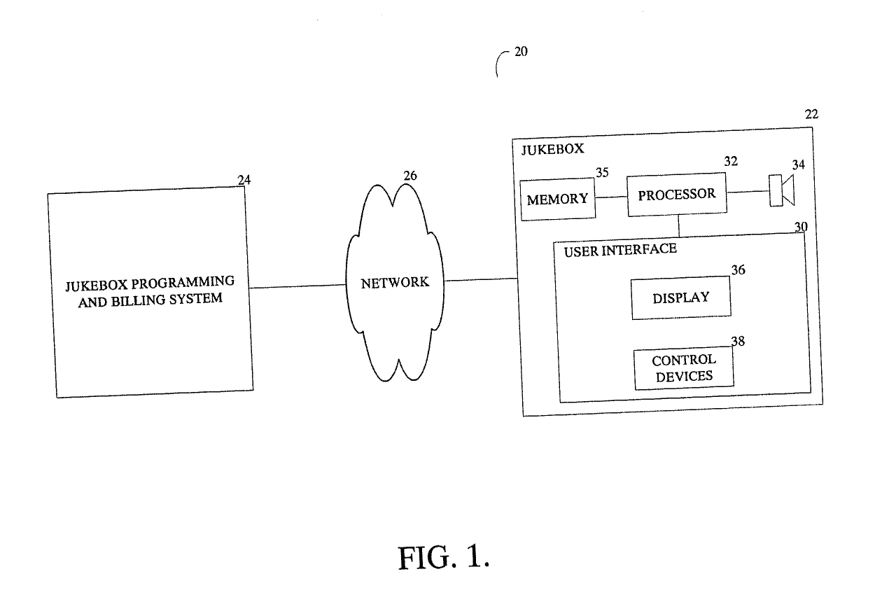

FIG. 1 illustrates a network-based digital jukebox system 20. The system 20 includes one or more jukeboxes 22 coupled to a jukebox programming and billing system 24 over a public or private data network 26. The jukebox 22 includes a user interface 30 coupled to a general purpose computer processor 32 that is coupled to a speaker system 34 and memory 35. The user interface 30 includes a display 36 and control devices 38. The system described below can be used in various other applications that require a user to select from a large volume of stored items.

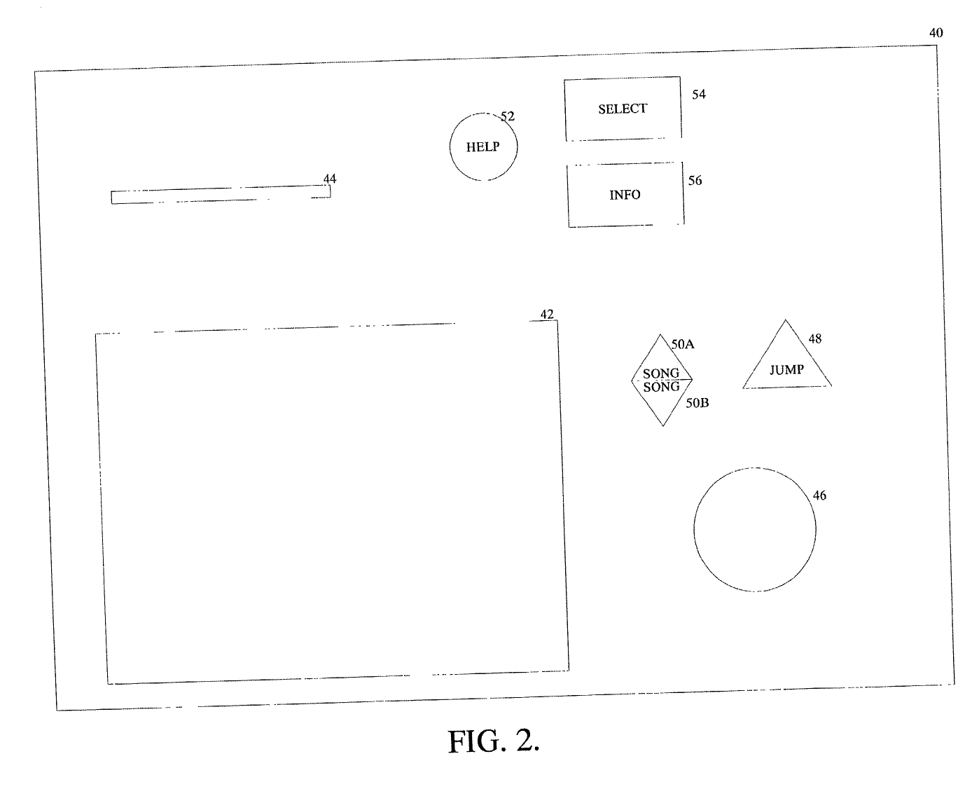

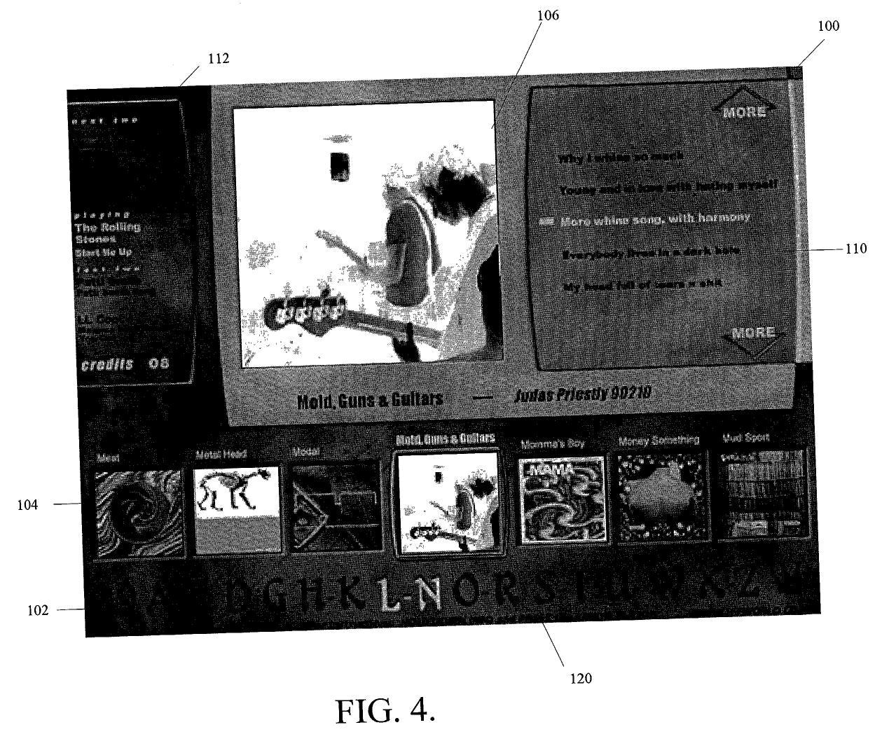

FIG. 2 illustrates a non-limiting example layout 40 of the user interface 30. The layout 40 is located on a box-like jukebox at a height that allows a user to easily use the user interface 30 while standing at the jukebox 22. The example layout 40 includes a display 42 located in the lower left corner of the layout 40. Above the display 42 is a money-receiving slot 44. Adjacent to the display 42 in the lower right corner of the layout 40 is a dial 46. Above the dial 46 is a jump button 48 and song highlight buttons 50A and B. Above the song highlight buttons 50A and B and adjacent to the money slot 44 is a circular help button 52, a song select button 54, and an artist information button 56. The functions of the buttons 48-56 and the dial 46 are described in more detail below and shown by way of a non-limiting example in FIG. 4. It will be appreciated that the buttons and dial may be implemented as other devices, such as toggle or throw switches, joysticks, potentiometers, a momentary contact switch, or other known input devices.

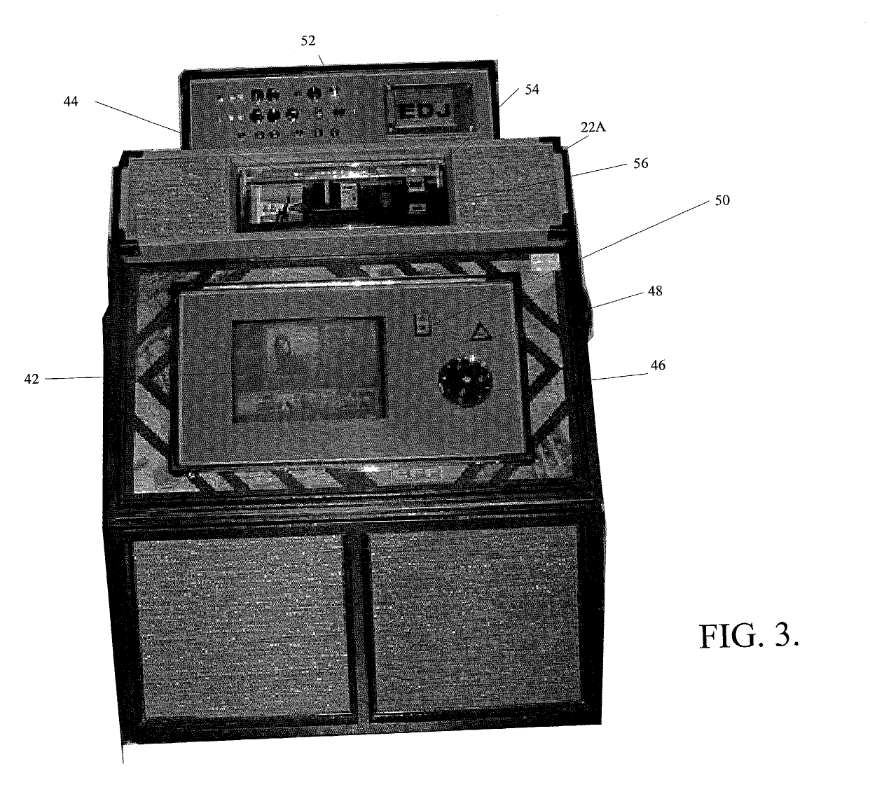

FIG. 3 illustrates a perspective view of a non-limiting example jukebox 22A and the general location of the components of a user interface 30.

FIG. 4 illustrates a non-limiting example interactive image 100 that is presented in the display area 42 of the layout 40 as shown in FIG. 2. The interactive image 100 includes a row of alphanumeric characters 102, an artist select row 104, a selected album image area 106, a song list area 110, and an information area 112. The alphanumeric row 102 is located at the bottom of the interactive image 100. Above the alphanumeric row 102 is the artist select row 104 and from left to right above the artist row 104 are the information area 112, the selected album image area 106, and the song list area 110.

Referring now to FIGS. 2 and 4, in order for a user of the jukebox to select music to be played by the jukebox, the user must first receive play credits. Play credits are generated after money is inserted in the money slot 44. The money slot 44 can be configured to receive paper or coin currency or credit/debit cards. The processor 32 determines the number of credits that a user has accrued based upon the amount of money deposited, credited, or debited. The number of credits is displayed at the bottom of the information area 112. When the user has play credits, the user can select one or more songs to be played. Songs are stored in the memory 34 according to a letter or number associated with the performing artist or album. The alphanumeric row 102 includes groups of letters and numbers. In order to find a desired song, the user first highlights a letter or number group from the alphanumeric row 102 according to the name of the associated album or artist. The dial 46 controls what group of letters or number group is highlighted along the alphanumeric row 102. In this example the following letters and numbers are grouped together into single selection groups: 0-9; A-C; D-G; H-K; L-N; O-R; S-T; U-W; and X-Z. It will be appreciated that other groupings can be implemented. When a group of letters or numbers is highlighted, all albums or artists names that are categorized and stored within the jukebox according to the highlighted letters/numbers are presented in the artist select row 104. Rotation of the dial 46 in the counterclockwise direction moves the highlighted selection in the alphanumeric row 102 from right to left, and clockwise movement of the dial 46 moves the highlighted selection in the alphanumeric row 102 from left to right.

As shown in FIG. 4, the highlighted selection in the alphanumeric row 102 is L-N. With the selection of L-N in the alphanumeric row 102 all artists or albums that are stored in the memory 35 as an L, M, or N artist/albums are presented in the artist select row 104. As shown in FIG. 4, seven artist/album images are illustrated in the artist select row 104. It will be appreciated that the jukebox may store more or less than seven artists/albums for a single alphanumeric group, as desired. When more than seven artists/albums are associated with a selected letter or number group, the dial 46 is used to scroll to artist/album images that are not presently displayed in the artist select row 104. Included in the middle of the artist select row 104 is a selection window 120. The artists/albums are preferably stored in alphabetical order by the artist/album name and preferably displayed according to the alphabetical order from left to right in the artist select row 104. In one embodiment, when a new selection is made in the alphanumeric row 102, the left-most artist/album image in the artist select row 104 is the first artist in the alphabetic listing associated with the alphanumeric row selection. In order to switch the dial 46 to provide input for scrolling in the artist select row 104, the user depresses the jump button 48. Once the jump button 48 has been activated (and after the dial 46 was used to interact with the alphanumeric row 102), all actions of the dial 46 are directed to the artist select row 104 and no longer to the alphanumeric row 102. A subsequent activation of the jump button 48 reverts inputs from the dial 46 to interact only with the alphanumeric row 102, and so on. A counterclockwise movement of the dial 46 scrolls an artist/album image into the right side of the artist select row 104 according to the alphabetic order and all the other presently displayed images are moved one space to the left. The left-most image is no longer displayed. The reverse is true for clockwise rotation of the dial 46. It will be appreciated that other types of artist/album ordering, such as genre, can be implemented.

As artist/album images scroll across the artist select row 104, the images pass through the artist selection window 120. As the images scroll across the artist select row 104, a new image is presented in the artist window 120. A larger version of the image within the artist window 120 is illustrated in the selected album image area 106. The artist/album images, usually images of the artist, album or CD cover, were previously inserted at the jukebox programming and billing system 24 and downloaded to the jukebox 22 over the network 26. Example embodiments of interaction of the jukebox 30 and the jukebox programming and billing system 24 are described in a copending application filed concurrently herewith and bearing attorney docket number EFFF-1-1001.

The songs associated with the artist/album image shown in the selected album image area 106 are presented in the song list area 110. Once the user has positioned the desired artist/album image in the artist display area 120 and the songs of that artist/album are displayed in the songs list area 110, the user highlights songs in the song list area 110 using the song buttons 50A and B. The song buttons 50A and B include an up arrow song button 50A and a down arrow song button 50B. Selection of the up arrow song button 50A highlights a song in the list that is located above the previously highlighted song. The down arrow song button 50B works opposite to the up arrow song button 50A. If the song list area 110 is not large enough to present all the songs associated with the artist/album, the song buttons 50 are used to vertically scroll through the associated song titles. Once the user has positioned the highlight over the desired song, then the user activates the song select button 54, which selects the highlighted song for play and removes a predefined number of credits from the number of credits available.

If a user desires to find out more information about the artist associated with the image displayed in the selected album image area 106, the user selects the artist info button 56. While the info button 56 remains depressed, text previously inserted by the artist or an agent representing the artist is presented in the song list area 110. Once the info button 56 is released, the information presented in the song list area 110 reverts back to the song list.

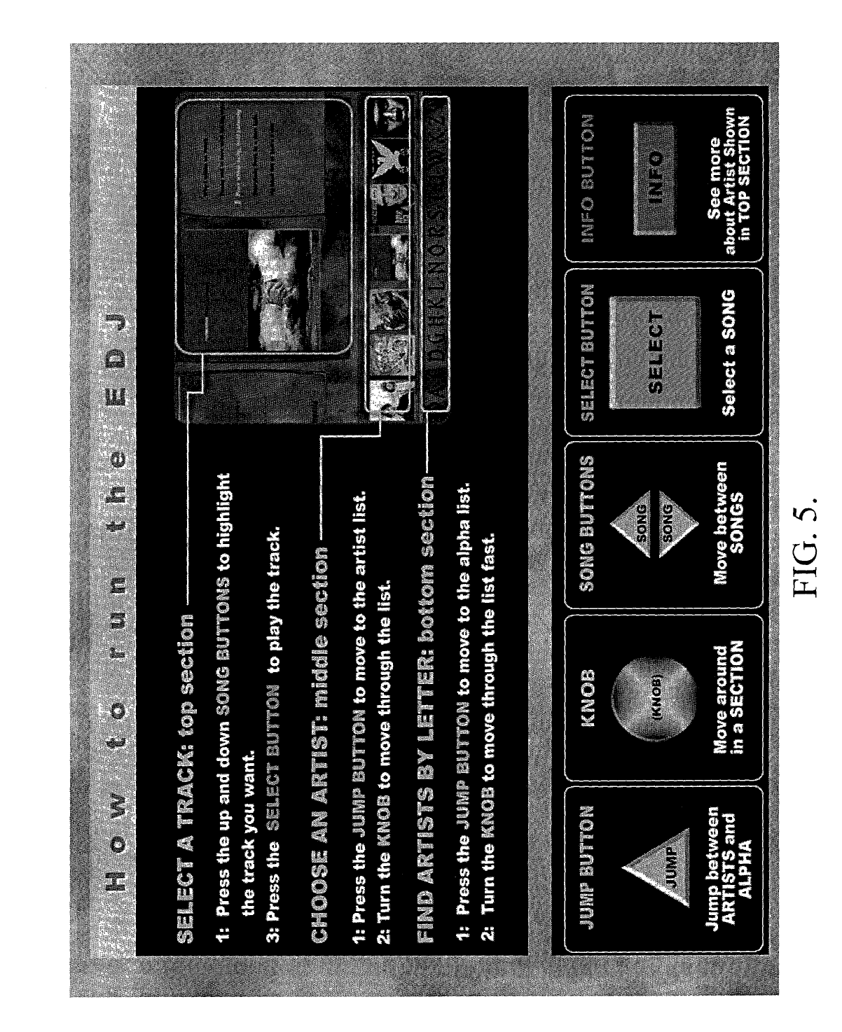

If the user desires help regarding how to operate the buttons in relation to the interactive display 100, the user depresses and holds the help button 52 which presents the example image shown in FIG. 5 on the display 42, preferably in the song list area 110.

In an alternate embodiment, the user interface 30 does not include a jump button 48. The dial 46 is also used to switch between the alphanumeric row 102 and the artist select row 104. In one non-limiting example the position of the dial 46 determines which of the alphanumeric row 102 and the artist select row 104 receives a scrolling signal generated by the dial 46. In this example, the dial 46 includes 5 positions: straight Up; one click left; two clicks left; one click right; and two clicks right. At the straight up position no scrolling signal is generated. At the one click right position, a clockwise scrolling signal is applied to the alphanumeric row 102. At the two clicks right position, a clockwise scrolling signal is applied to the artist select row 104. The opposite is true for the left positions.

In another non-limiting example, the rotational distance or speed of dial movement determines which of the alphanumeric row 102 and the artist select row 104 receive the generated scrolling signal. In this example, a clockwise movement of the dial 46 less than a threshold amount sends a clockwise scrolling signal to the alphanumeric row 102. A clockwise movement of the dial 46 greater than the threshold amount sends a clockwise scrolling signal to the artist select row 104.

In another embodiment, only one of the alphanumeric row 102 and the artist select row 104 are displayed on the display 42 at one time. The mechanism (i.e. the dial 46 or the jump button 48) that controls where scrolling input is applied determines which of the alphanumeric row 102 and the artist select row 104 to display.

In accordance with the present invention, a jukebox is defined as a unit for storage and/or playback of digital media.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A jukebox comprising:
a display;
a memory for storing graphic files and associated music files;
a processor coupled to the display and memory, the processor comprising:
a graphical user interface component for generating an image for presentation on the display, the graphical user interface component including:
an alphanumeric list component for generating selectable alphanumeric components, wherein the stored graphic and music files are associated with one or more alphanumeric components;
an album/artist component for generating a plurality of images for display based on a selection from the generated alphanumeric list and the associated graphic and music files; and
an information component for generating images and text for display based on a selection from the generated images and the associated graphic, music, and text files; and
a song selection component for generating a list of selectable songs based on a selection of one of the images, wherein the generated alphanumeric components, one or more of the images, and song list are displayed on the display; and
a controlling device coupled to the processor, the controlling device including:
a scrolling device for generating a scrolling signal when operated;
a switch device for generating a switching signal when operated; and
a song selection component for selecting a song from the generated song list,
wherein the processor sends the generated scrolling signal to at least one of the alphanumeric list component, the album/artist select component, or the song selection component based on the generated switching signal.

2. The jukebox of claim 1, wherein the plurality of images are associated with at least one of an album, an artist, or a group of artists.

3. The jukebox of claim 1, wherein the scrolling device is a joystick.

4. The jukebox of claim 1, wherein the scrolling device is a dial.

5. The jukebox of claim 1, wherein the scrolling device is a potentiometer.

6. The jukebox of claim 1, wherein the switching device is a throw switch.

7. The jukebox of claim 1, wherein the switching device is a toggle switch.

8. The jukebox of claim 1, wherein the switching device is a momentary contact switch.

9. The jukebox of claim 1, wherein the switching and scrolling devices are the same device.

10. The jukebox of claim 1, wherein the switching and scrolling device generates a scrolling signal within a range of positions and a switching signal at one or more points in the range of positions.

11. The jukebox of claim 1, wherein the switching and scrolling device generates a scrolling signal when moved within a speed range and a switching signal at one or more points in the speed range.

12. The jukebox of claim 2, wherein the album/artist select component includes an album/artist identification component for identifying the generated album or artist images.

13. The jukebox of claim 12, wherein the graphical user interface further includes an album/artist image component for generating an image associated with an identified album or artist image.

14. A jukebox graphical user interface comprising:
an alphanumeric list component for generating selectable alphanumeric components, wherein the stored graphic, text, and music files are associated with one or more alphanumeric components;
an album/artist select component for generating a plurality of images for display based on a selection from the generated alphanumeric list and the associated graphic and music files;
an information select component for generating images and text of at least one of an album or artist for display based on selection from the generated images and the associated graphic, music, and text files;
a song selection component for generating a list of selectable songs based on a selection of one of the images, wherein the generated alphanumeric components, one or more of the images, and song list are displayed on the display; and
a controlling signal receiving component for receiving at least one of a scrolling signal, a switching signal and a song select signal, sending the scrolling signal to at least one of the alphanumeric list component, the album/artist select component, or the song selection component based on the switching signal, and selecting a song from the list of selectable songs based on the song select signal.

15. A method comprising:
storing a plurality of graphic files and associated music files and associated text files;
displaying a plurality of alphanumeric components, wherein the stored graphic, text, and music files are associated with one or more of the alphanumeric components;
selecting one of the plurality of alphanumeric components;
displaying a plurality of images based on the selection of one of the alphanumeric components and the associated graphic, text, and music files;
selecting one of the displayed images;
displaying a list of songs based on the selection of one of the images;
selecting a song from the displayed list of songs displaying the displayed alphanumeric components, one or more of the images, and song list on a display device;

16. The method of claim 15, wherein the displayed plurality of images are associated with at least one of an album, an artist, or a group of artists.

17. The method of claim 15, wherein selecting one of the plurality of alphanumeric components includes selecting one of the plurality of alphanumeric components using a scrolling device.

18. The method of claim 15, wherein selecting one of the displayed images includes selecting one of the images using a scrolling device.

19. The method of claim 15, selecting a song from the displayed list of songs includes selecting a song using a scrolling device.

20. The method of claim 15, further comprising identifying the selected image.

21. The method of claim 15, wherein the switching and scrolling are performed by the same device.

22. The method of claim 21, wherein switching and scrolling when performed by the same device generates a scrolling signal within a range of positions and a switching signal at one or more points in the range of positions.

23. The method of claim 21, wherein switching and scrolling when performed by the same device generates a scrolling signal when moved within a speed range and a switching signal at one or more points in the speed range.
